(19) United States
(12) Patent Application Publication
(10) Pub. No.: US 2018/0026911 A1
(43) Pub. Date: Jan. 25, 2018

(54) SYSTEM AND METHOD FOR PROVIDING A RESOURCE USAGE ADVERTISING FRAMEWORK FOR SFC-BASED WORKLOADS

(71) Applicant: Cisco Technology, Inc., San Jose, CA (US)

(72) Inventors: Paul Anholt, Raleigh, NC (US); Gonzalo Salgueiro, Raleigh, NC (US); Sebastian Jeuk, San Jose, CA (US)

(21) Appl. No.: 15/219,105

(22) Filed: Jul. 25, 2016

(51) Int. Cl. H04L 12/927; H04L 29/06; H04L 12/26; H04L 12/46

(52) U.S. Cl. CPC H04L 47/805; H04L 12/4641; H04L 69/22; H04L 43/16

(57) ABSTRACT

Disclosed is a system and method of providing a system for managing resource utilization for a service function chain. A method includes receiving, from a virtual network function operating in a container within a service function chain, and at a container orchestration layer, resource usage data. The method includes determining whether the resource usage data has surpassed a threshold to yield a determination. When the determination indicates that the threshold is met, the method includes migrating the container to a new location within a network. The order of services in a service function chain can remain the same in the migrating but the virtual service functions can move to other virtual or physical locations.

### TECHNICAL FIELD

The present disclosure relates to mechanism to add resource utilization on a hop-by-hop basis to the service function chain headers. Each network function within a defined service function chain adds its own resource utilization data to the metadata field while having the option to act upon the utilization metadata provided by other network functions.

### BACKGROUND

Containers deployed in a service function chain (SFC) environment do not have a mechanism to communicate resource usage towards other virtual network functions in the SFC. The lack of the functionality of communicating resource usage can create various issues within a managed cloud. For example, assume a micro-service did not respond within the acceptable period because of an out of memory condition. A path to isolate the out of memory condition can be to (1) receive an alert that the micro-service is generating errors, (2) review manually a logging dashboard to find an upstream service in the chain is not responding in a timely manner, (3) inspect manually yet another dashboard to identify which containers are memory constrained, and (4) deploy additional containers to relieve the memory pressure. The issue also applies beyond just containers to virtual machines or bare metal network function deployments as well.

As can be appreciated, the above pathway to resolving the problem associated with a micro-service that is part of a larger SFC chain is cumbersome and time consuming.

### BRIEF DESCRIPTION OF THE DRAWINGS

The disclosure will be readily understood by the following detailed description in conjunction with the accompanying drawings in which:

FIG. 1 illustrates the basic computing components of a computing device according to an aspect of this disclosure.

FIG. 2 illustrates the general context in which the present disclosure applies.

FIG. 3 illustrates an example method.

FIG. 4 illustrates another example method.

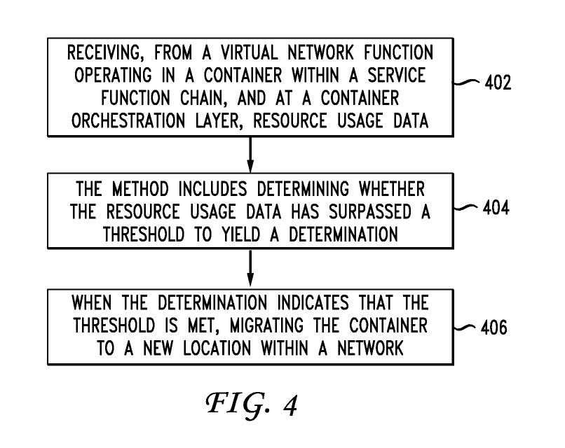

### DESCRIPTION OF EXAMPLE EMBODIMENTS

### Overview

The concepts disclosed herein simplify the problem described above by advertising resource usage across the service function chain (SFC). The concepts disclosed herein can solve various problems, including (1) resource utilization exchange in the SFC deployment, (2) resource utilization based SFC instantiation, and (3) schedule network function usage based on their advertised resource utilization. The overall chain utilization information can be leveraged centrally for different use-cases such as pro-actively re-scheduling workloads to avoid over-utilization. The framework provides a way to advertise resource usage and then leverage the information received to make improvements on usage across a SFC.

Disclosed are systems and methods of providing a system for managing resource utilization for the SFC. As an example, a method aspect of the disclosure can include receiving, from a virtual network function operating in a container within a service function chain, and at a container orchestration layer, resource usage data. An example transport mechanism to enable the receipt of the resource usage data on a container basis can include using the service function chain headers (or network service header or NSH). The method includes determining whether the resource usage data has surpassed a threshold to yield a determination and, when the determination indicates that the threshold is met, migrating the container to a new location within a network. The order of services in a service function chain can remain the same in the migration, but the virtual service functions can move to other physical, logical or virtual locations.

The resource usage data can provide information on how much and in what way is a container being utilized. Memory, CPU information, bandwidth, and any other resource, can be reported to a controller which is in communication with the various containers with the SFC. The SFC can be dynamically be modified based on this information. For example, the SFC chain can have the traffic flow modified such that the system does not over-utilize a container and the services that one container is offering.

In one aspect, the concept of using NSH header information to report on resource utilization information for network functions on a container or virtual network function level to a controller can be implemented for a number of different approaches. For example, the resource utilization information can be used to trigger a number of controller functions to make modifications, orchestration, migration, changes, traffic routing changes, and/or improvements to the SFC. These changes can be made to implement policies or service level agreements at the network layer based on the network utilization received from the various containers. The data received from the VNFs can be “live” or in real-time and dynamic changes and modifications to the SFC environment can be virtually live.

### Description

Cloud and service providers can host and provision numerous services and applications, and service a wide array of customers or tenants. These providers often implement cloud and virtualized environments, such as software-defined networks (e.g., OPENFLOW, SD-WAN, etc.) and/or overlay networks (e.g., VxLAN networks, NVGRE, SST, etc.), to host and provision the various solutions. Software-defined networks (SDNs) and overlay networks can implement network architectures that provide virtualization layers, and may decouple applications and services from the underlying physical infrastructure. Further, the capabilities of overlay and SDNss can be used to create service chains of connected network services, such as firewall, network address translation (NAT), or load balancing services, which can be connected or chained together to form a virtual chain or service function chain (SFC).

SFCs can be used by providers to setup suites or catalogs of connected services, which may enable the use of a single network connection for many services, often with different characteristics. SFCs can have various advantages. For example, SFCs can enable automation of the provisioning of network applications and network connections.

Specific services or functions in an SFC can be virtualized through network function virtualization (NFV). A virtualized network function, or VNF, can include one or more virtual machines (VMs) or software containers running specific software and processes. Accordingly, with NFV, custom hardware appliances are generally not necessary for each network function. The virtualized functions can thus provide software or virtual implementations of network functions, which can be deployed in a virtualization infrastructure that supports network function virtualization, such as SDN. NFV can provide flexibility, scalability, security, cost reduction, and other advantages.

The complexity of virtualized networks and variety of services or solutions provided by the various network functions in SFCs may also present significant challenges in monitoring and managing resource usage. Accordingly, as further explained herein, resource usage information from containers can be used by a software-defined network controller or an SFC classifier to make informed decisions when creating and managing an SFC chain. Containers can enable a cloud system to configure physical and virtual network infrastructure and network service through templates that enable a level of abstraction. Once the definition of the service is created, the network services can interoperate with computing and storage resources to deliver end-to-end cloud service and enable different network services.

The advantages of using containers include the ability to manage the interdependencies of resources, helping ensure that Layer 2 through 7 connectivity works logically and can match physically the design of the network topology. Other advantages include the ability to (1) span the entire network, from a Multiprotocol Label Switching (MPLS) routed core network coming in from an IP Next-Generation network (IP NGN) to the server access switch layer, including all the firewall and load-balancing services at the distribution layer, (2) integrate with each virtual machine being added through a portal through the mapping of virtual network interface cards (NICs) and port groups to the container names, which in turn are mapped to the underlying access VLANs and other settings at the virtualized server and network layers, (3) Allow secure, compliant segregation of virtual and physical resources per tenant, and (4) Enable interoperability of industry-standard services (such as VLANs and VPNs) across providers and infrastructure.

Compared to virtual machines, containers are lightweight, quick and easy to spawn and destroy. With the increasing interest in container-based deployments, the network has to adapt to container-specific traffic patterns. Container technology, such as DOCKER and LINUX CONTAINERS (LXC), is intended to run a single application and does not represent a full-machine virtualization. A container can provide an entire runtime environment: an application, plus all its dependencies, libraries and other binaries, and configuration files needed to run it, bundled into one package. By containerizing the application platform and its dependencies, differences in operating system distributions and underlying infrastructure are abstracted away.

With virtualization technology, the package that can be passed around is a virtual machine and it includes an entire operating system as well as the application. A physical server running three virtual machines would have a hypervisor and three separate operating systems running on top of it. By contrast, a server running three containerized applications as with DOCKER runs a single operating system, and each container shares the operating system kernel with the other containers. Shared parts of the operating system are read only, while each container has its own mount (i.e., a way to access the container) for writing. That means the containers are much more lightweight and use far fewer resources than virtual machines.

Other containers exist as well such as the LXC that provide an operating-system-level virtualization method for running multiple isolated Linux systems (containers) on a control host using a single Linux kernel. These containers are considered as something between a chroot (an operation that changes the apparent root directory for a current running process) and a full-fledged virtual machine. They seek to create an environment that is as close as possible to a Linux installation without the need for a separate kernel.

The present disclosure introduces a classification/identification/isolation approach for containers. The concepts can also apply to VMs and other components like endpoints or endpoint groups. The introduced identification mechanism allows the unique (depending on the scope everything from a cluster to a whole cloud providers network) identification of containers and their traffic within the network elements.

Disclosed is a mechanism to add resource utilization on a hop-by-hop basis to the data retrieved from headers such as the service function chain headers (network service header or NSH). If each network function is aware of the resource utilization of the previous network function, there can be ways of modifying policy enforcement based on this information. For example, the traffic flow can be improved because of a depletion of resources from a previous function on any given VNF. Each network function within a defined service function chain adds its own resource utilization data to the metadata field while having the option to act upon the utilization metadata provided by other network functions. The overall chain utilization information can be leveraged centrally for a plurality of different use-cases such as a pro-actively re-scheduling workloads to avoid over-utilization.

By including resource usage data within the NSH framework, additional value can be delivered to networks such as rapid isolation of resource constraints, allowing central SDN controllers (Open Daylight, etc) to aggregate and act upon resource consumption data, container orchestration software can deploy additional containers or migrate containers based off actual resource usage, and dynamically instantiate or update service function chains based on resource utilization reported by network functions. The combination of the above advantages gives a cloud service operator a quicker means to resolve service impacting issues. This concepts disclosed herein can be used by a plurality of entities in a cloud environment or more generically in a containerized deployment. A provider could leverage the resource utilization information gathered in a service function chain to dynamically adjust workload distribution across network functions avoid over-utilization and allowing for service level agreement enforcement.

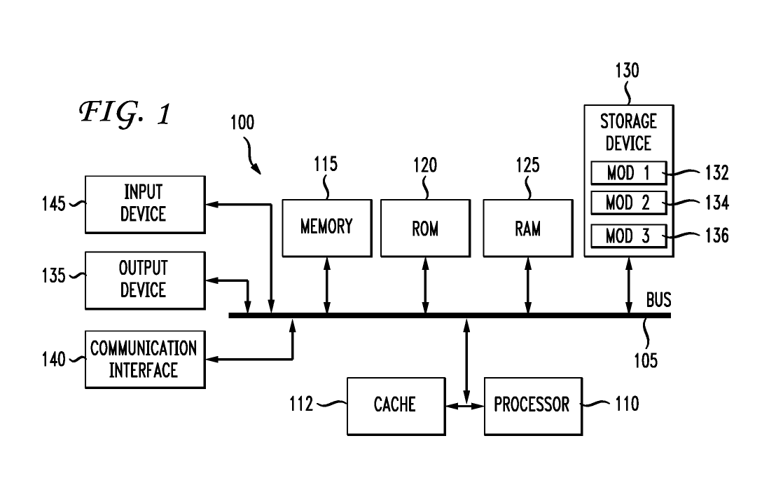

FIG. 1 discloses some basic hardware components that can apply to system examples of the present disclosure. Following the discussion of the basic example hardware components, the disclosure will turn to the concept of resource usage advertising for SFC-based workloads. With reference to FIG. 1, an exemplary system and/or computing device 100 includes a processing unit (CPU or processor) 110 and a system bus 105 that couples various system components including the system memory 115 such as read only memory (ROM) 120 and random access memory (RAM) 125 to the processor 110. The system 100 can include a cache 112 of high-speed memory connected directly with, in close proximity to, or integrated as part of the processor 110. The system 100 copies data from the memory 115, 120, and/or 125 and/or the storage device 130 to the cache 112 for quick access by the processor 110. In this way, the cache provides a performance boost that avoids processor 110 delays while waiting for data. These and other modules can control or be configured to control the processor 110 to perform various operations or actions. Other system memory 115 may be available for use as well. The memory 115 can include multiple different types of memory with different performance characteristics. It can be appreciated that the disclosure may operate on a computing device 100 with more than one processor 110 or on a group or cluster of computing devices networked together to provide greater processing capability. The processor 110 can include any general purpose processor and a hardware module or software module, such as module 1 132, module 2 134, and module 3 136 stored in storage device 130, configured to control the processor 110 as well as a special-purpose processor where software instructions are incorporated into the processor. The processor 110 may be a self-contained computing system, containing multiple cores or processors, a bus, memory controller, cache, etc. A multi-core processor may be symmetric or asymmetric. The processor 110 can include multiple processors, such as a system having multiple, physically separate processors in different sockets, or a system having multiple processor cores on a single physical chip. Similarly, the processor 110 can include multiple distributed processors located in multiple separate computing devices, but working together such as via a communications network. Multiple processors or processor cores can share resources such as memory 115 or the cache 112, or can operate using independent resources. The processor 110 can include one or more of a state machine, an application specific integrated circuit (ASIC), or a programmable gate array (PGA) including a field PGA.

The system bus 105 may be any of several types of bus structures including a memory bus or memory controller, a peripheral bus, and a local bus using any of a variety of bus architectures. A basic input/output system (BIOS) stored in ROM 120 or the like, may provide the basic routine that helps to transfer information between elements within the computing device 100, such as during start-up. The computing device 100 further includes storage devices 130 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. The storage device 130 is connected to the system bus 105 by a drive interface. The drives and the associated computer-readable storage devices provide nonvolatile storage of computer-readable instructions, data structures, program modules and other data for the computing device 100. In one aspect, a hardware module that performs a particular function includes the software component stored in a tangible computer-readable storage device in connection with the necessary hardware components, such as the processor 110, bus 105, an output device such as a display 135, and so forth, to carry out a particular function. In another aspect, the system can use a processor and computer-readable storage device to store instructions which, when executed by the processor, cause the processor to perform operations, a method or other specific actions. The basic components and appropriate variations can be modified depending on the type of device, such as whether the computing device 100 is a small, handheld computing device, a desktop computer, or a computer server. When the processor 110 executes instructions to perform “operations”, the processor 110 can perform the operations directly and/or facilitate, direct, or cooperate with another device or component to perform the operations.

Although the exemplary embodiment(s) described herein employs a storage device such as a hard disk 130, other types of computer-readable storage devices which can store data that are accessible by a computer, such as magnetic cassettes, flash memory cards, digital versatile disks (DVDs), cartridges, random access memories (RAMs) 125, read only memory (ROM) 120, a cable containing a bit stream and the like, may also be used in the exemplary operating environment. According to this disclosure, tangible computer-readable storage media, computer-readable storage devices, computer-readable storage media, and computer-readable memory devices, expressly exclude media such as transitory waves, energy, carrier signals, electromagnetic waves, and signals per se.

To enable user interaction with the computing device 100, an input device 145 represents any number of input mechanisms, such as a microphone for speech, a touch-sensitive screen for gesture or graphical input, keyboard, mouse, motion input, speech and so forth. An output device 135 can also be one or more of a number of output mechanisms known to those of skill in the art. In some instances, multimodal systems enable a user to provide multiple types of input to communicate with the computing device 100. The communications interface 140 generally governs and manages the user input and system output. There is no restriction on operating on any particular hardware arrangement and therefore the basic hardware depicted may easily be substituted for improved hardware or firmware arrangements as they are developed.

For clarity of explanation, the illustrative system embodiment is presented as including individual functional blocks including functional blocks labeled as a “processor” or processor 110. The functions these blocks represent may be provided through the use of either shared or dedicated hardware, including, but not limited to, hardware capable of executing software and hardware, such as a processor 110, that is purpose-built to operate as an equivalent to software executing on a general purpose processor. For example the functions of one or more processors presented in FIG. 1 can be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 120 for storing software performing the operations described below, and random access memory (RAM) 125 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited tangible computer-readable storage devices. Such logical operations can be implemented as modules configured to control the processor 110 to perform particular functions according to the programming of the module. For example, FIG. 1 illustrates three modules Mod1 132, Mod2 134 and Mod3 136 which are modules configured to control the processor 110. These modules may be stored on the storage device 130 and loaded into RAM 125 or memory 115 at runtime or may be stored in other computer-readable memory locations.

One or more parts of the example computing device 100, up to and including the entire computing device 100, can be virtualized. For example, a virtual processor can be a software object that executes according to a particular instruction set, even when a physical processor of the same type as the virtual processor is unavailable. A virtualization layer or a virtual “host” can enable virtualized components of one or more different computing devices or device types by translating virtualized operations to actual operations. Ultimately however, virtualized hardware of every type is implemented or executed by some underlying physical hardware. Thus, a virtualization compute layer can operate on top of a physical compute layer. The virtualization compute layer can include one or more of a virtual machine, an overlay network, a hypervisor, virtual switching, and any other virtualization application.

The processor 110 can include all types of processors disclosed herein, including a virtual processor. However, when referring to a virtual processor, the processor 110 includes the software components associated with executing the virtual processor in a virtualization layer and underlying hardware necessary to execute the virtualization layer. The system 100 can include a physical or virtual processor 110 that receive instructions stored in a computer-readable storage device, which cause the processor 110 to perform certain operations. When referring to a virtual processor 110, the system also includes the underlying physical hardware executing the virtual processor 110.

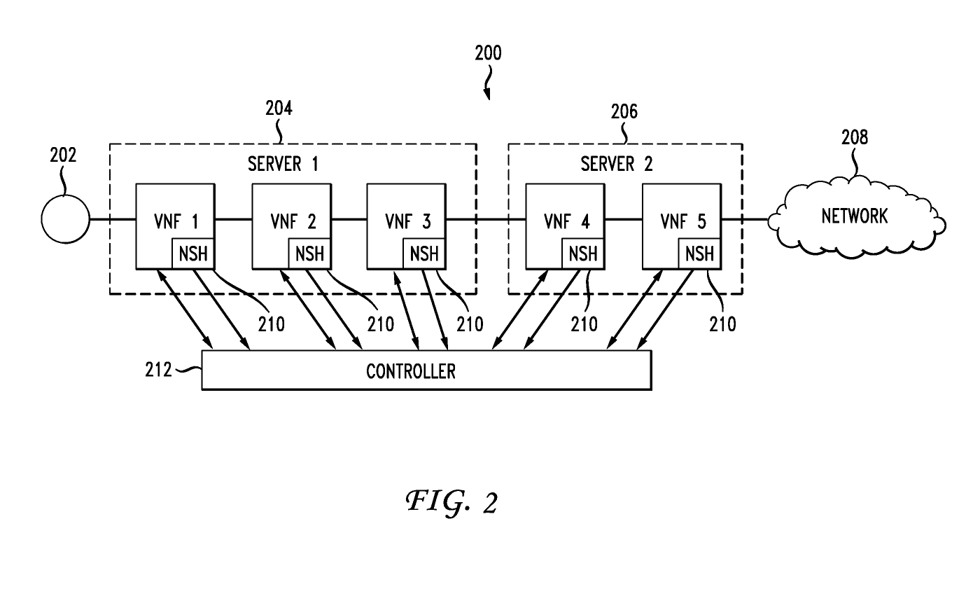

The disclosure now turns to FIG. 2, which illustrates a general structure 200 to which the concepts disclosed herein apply. A common troubleshooting problem that arises in cloud deployments is the ability to identify, isolate and quickly remediate a resource constraint problem. This is especially true for containerized Virtualized Network Functions (VNF) in a Service Function Chaining environment (SFC). Shown in FIG. 2 is a service function chain that includes workload/data traffic 202 which is submitted to the chain. A first server 204 contains virtual network functions 1, 2 and 3. These can of course be different network functions and they can advertise different utilization. Another server 206 contains virtual network functions 4 and 5 and which connects to a network 208. The virtual network functions represent the service function chain and the order thereof. The network service header 210 is one example of a data field that is used as part of the operation of containerized VNFs which can be accessed for reporting resource usage data. The different VNFs can advertise different types of utilization.

This disclosure provides a resource advertising framework that makes use of the metadata field (such as the NSH field) to expedite troubleshooting of resource oversubscription/depletion issues as well as provide an automated and intelligent mechanism to remediate and recover from resource constraints in a cloud environment. A mechanism is proposed herein by which a variety of resource usage data (mem_info, compute usage, application needs, bandwidth usage, data related usage or needs, etc) can be advertised from containerized VNFs within an SFC. In one aspect, the advertising of network resources (bandwidth, link utilization, etc), in addition to the host-based resources mentioned above, can provide a complete picture of the cloud environment and the underlying network infrastructure. This advertisement of host (and potentially network) resources is performed, on one example, by making use of the NSH (Type 1 or 2) metadata fields as a means of centralizing at a controller 212 this valuable information to be consumed as needed.

In some cases, the NSH can be a header, such as a data plane header, added to frames/packets. The NSH can contain information for service chaining, service path information, as well as metadata added and consumed by network nodes and service elements. The NSH can also include information about performance requirements or conditions, as well as network resources consumed and/or needed, such as bandwidth, throughput, link utilization, latency, link cost, IGP metrics, memory usage, application usage, modules loaded, storage usage, processor utilization, error rate, etc.

Each container can report its usage. Other data fields could be used as well. FIG. 2 illustrates multiple VNFs 1-5 that can be hosted by a single or multiple bare-metal servers 204, 206 this mechanism can report host-based (as well as underlying network-based) resource usage for the respective VNFs as well as for the hosting bare-metal server (as a per container fraction of the total usage, etc.).

The data reported can be at the host level, or on a VNF basis as well. For example, VNF1 can be determined to be over-utilized based on memory or storage usage. A controller 212 can receive the resource usage from the header and make changes to the utilization for the SFC. In one aspect the controller 212 is in a container orchestration layer in the network. In this respect, the controller 212 not only centralizes and receives the various usage reports but also is in communication with the various containers and can make changes to improve the data processing, traffic flow, memory, usage, bandwidth usage, and so forth for the SFC. The controller 212, based on the received usage information, can implement maintenance for one or more software or hardware elements, schedule an action to be taken, and so forth. For example, if a certain container is always at 80% utilization, the controller 212 can add additional resources to that container to improve its utilization rate.

For example, assume VNF2 reports a certain usage to the controller 212 related to resource utilization. The report at the controller 212 can cause the controller to make a modification or change to the functioning of another VNF such as VNF1. If VNF2 is over-utilizing memory usage, the data flow from VNF1 may be modified by the controller 212 or rerouted to remedy the memory overutilization in VNF2. In another example, if VNF3 is over-utilized with respect to traffic flow, that fact can be reported to the controller 212 and an instruction can be provided to an NSH forwarder which implements a policy which governs how data is transmitted from VNF2 to VNF3. The new policy could adjust to accommodate the reduction in traffic flow or increase in traffic flow from VNF2 to VNF3, or may reroute the data. Thus, NSH forwarders can be modified by the controller based on the usage data and in this way functionality at one container can be affected by usage reports from other containers. In other words, instead of forwarding the data from VNF2 to VNF3, the system may have to accommodate the change in function or re-route.

The resource usage advertisements can be centralized, for example at the controller 212, consumed and acted upon by a central software defined network controller (OpenDaylight, etc.) 212. This host-based (as well as potential network-based) resource usage can then be used for a number of purposes, such as enhanced centralized visibility of the data center and underlying network infrastructure, simplified troubleshooting of resource utilization (i.e. oversubscription, depletion, etc.) issues, etc. In yet another aspect, the system can automate the remediation and mitigation of resource utilization (i.e. oversubscription, depletion, etc.) issues in a dynamic and intelligent fashion. The NSH-based resource advertisement can be centralized and consumed by the SDN controller 212 in a manner that intelligent automation is built in such that workload migration is proactively triggered based on thresholds or resource usage-based policy enforcement decisions.

Imagine a server 204, 206 hosting multiple containers. Assume one container is experiencing a resource constraint (memory depletion due to a leak, compute oversubscription, etc.). The advertising/reporting approach enables this information to be automatically detected based on proactive triggers and the issue can be reported to the container orchestration layer (DOCKER, DOCKERSWARM, CLOUDIFY, etc) to trigger automated migration of the resource constrained container to a more suitable location able to provide the necessary resources to run it properly.

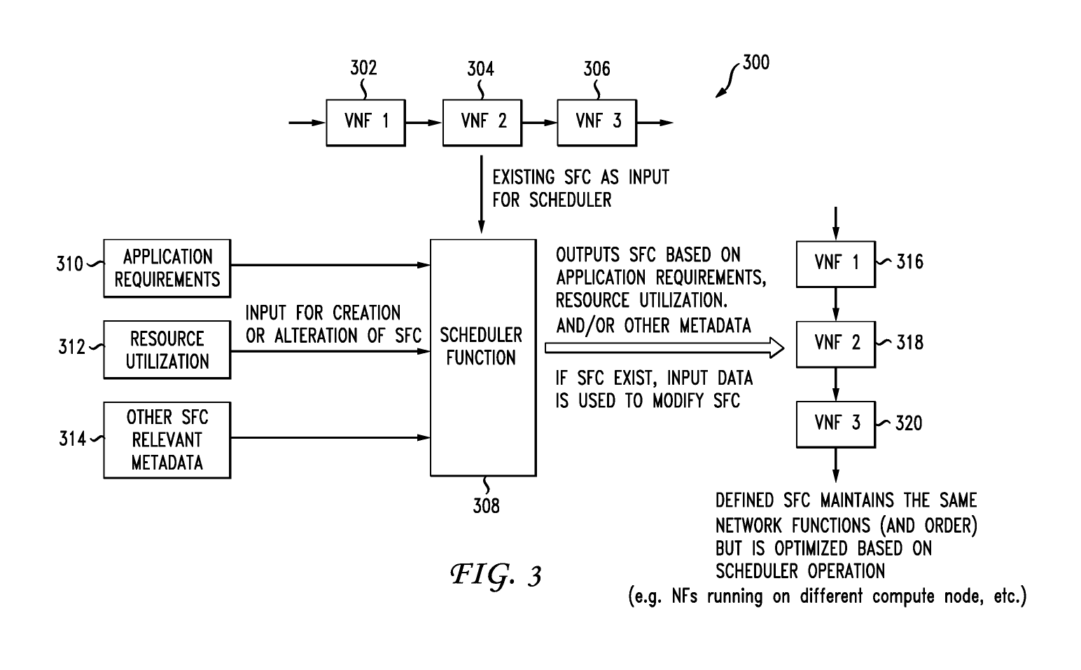

Another aspect allows the remediation and mitigation of resource utilization (i.e. oversubscription, depletion, etc.) by dynamically re-scheduling workloads to less utilized network functions. FIG. 3 illustrates this approach. A scheduler 308 is an underlying function that is tasked with selecting the optimal, or preferred (containerized) VNF out of a pool based on the metadata inputs it receives (e.g. resource utilization, application requirements, etc.). The scheduler can be in a container orchestration layer of the network. The scheduler 308 defines network functions and provides certain input to the scheduler 308 to aid its making of SFCs. For example, a tenant creates a service function chain (including, for example, VNFs 302, 304, 306 in their proper order) selecting a firewall as one of the network functions in the chain. Internally, the scheduler 308 uses the metadata information it receives on resource utilization of firewall VNF containers deployed across the network and it selects the optimal (or preferred) container based on resource availability and/or usage. Here, the decisions based on previously defined policies (for example, a policy could define the selection of firewall services running in a container with a utilization under 40%). The scheduler 308 enables the policy-driven selection of a network function out of a pool based on resource utilization or other potentially other metadata information. Notably, the reference to an “optimal” container is not meant to be an absolute. It can refer more practically to a near optimal or preferred container which is sufficient but not necessarily strictly “optimal.”

Part of a created SFC, the VNFs can advertise their utilization and if thresholds are hit on one or more VNFs, the scheduler 308 will use that information to create new SFCs. For if the system or a user wants to rebuild or build a new SFC to be built out of the same VNFs. However, if some VNFs are reporting overutilization or are close to overutilization, the schedule 308 can avoid using these VNFs and either create a new VNF with the same function or redistribute the load on the existing VNFs.

In yet another aspect, the resource advertisement (of potentially both host and network usage) can be used to automate the efficiency of how traffic is routed to different VNFs. Imagine how this information can be fed back to the classifier (or done centrally by SDN controller) to load-balance traffic to mitigate oversubscription or make more efficient use of existing resources.

Finally, in another aspect, the centralized consumption of the advertised resource usage information can be a means of determining the need for an upgrade as well as providing the ability to instantiate a period of quiescence for the identified container. This resource usage information can intelligently trigger (based on a variety of possible installed resource policies) a complete stop of traffic to the affected container so that maintenance/upgrade can be performed and then also automatically implement a resumption of traffic to the newly upgraded container.

The diagram in FIG. 3 depicts the scheduler 308 receiving as input such data as one or more of application requirements 310, the resource utilization information 312, other SFC relevant metadata 314. The data 310, 312, 314 can be provided by the network and containers running network functions 30-2, 304, 306 in a service chain. The scheduler 308 uses the information to define a new service function chain 316, 318, 320 with the required network functions and in the desired order. If an SFC already exists, the scheduler 308 leverages the provided information to dynamically modify the SFC by, for example, leveraging network functions that are less utilized. The newly defined SFC can maintain the same network functions and/or order but is improved relative to the previous configuration based on the scheduler operation. The order of the VNFs shown in FIG. 3 can be modified. Typically, the order of the processing is important and will typically stay the same. For example, one VNF may involve a firewall or routing functions and the order of processing the data should stay the same. However, in some SFC's, there may be some data that does not logically have to take a certain path or a certain order. The received information at the scheduler 308 can be used to modify even the order of VNFs. Thus, overutilization information can be used to modify either the hardware on which the VNFs function but also the order of the VNFs can be changed, or one or more VNF may be dropped and optionally replaced with a new VNF.

FIG. illustrates a method aspect of this disclosure. Disclosed is a system and method of providing a system for managing resource utilization for a service function chain. A method includes receiving, from a virtual network function operating in a container within a service function chain, and at a container orchestration layer, resource usage data (402). The method includes determining whether the resource usage data has surpassed a threshold to yield a determination (404) and, when the determination indicates that the threshold is met, migrating the container to a new location within a network (406). The order of services in a service function chain can remain the same in the migrating but the virtual service functions can move to other locations.

The container orchestration layer can perform such actions as integrating orchestration, fulfillment, control, performance, assurance, usage, analytics, security, and policy of enterprise networking services based on open and interoperable standards. The layer can also include the ability to program automated behaviors in a network to coordinate the required networking hardware and software elements to support applications and services. The container orchestration layer can start with customer service orders, generated by either manual tasks or customer-driven actions such as the ordering a service through a website. The application or service would then use the container orchestration layer technology to provision the service. This might require setting up virtual network layers, server-based virtualization, or security services such as encrypted tunnel.

The resource usage data can be communicated via a network service header field, such as type 1 or type 2 metadata. The threshold can be based on a usage-based policy, some other policy or service level agreement. The resource usage data can include one of memory depletion, compute oversubscription, resource utilization, application requirements, and bandwidth. FIG. 3 shows the “new location” in the network which can include a containerized virtual network function chosen from a pool of containerized network functions.

The method can also include receiving one of application requirements and service function chain metadata and receiving existing service function chain data. Based on this additional data, the method can include modifying the service function chain by maintaining a service function chain functions and/or order while changing a location in the network on which a respective virtual network function within the service function chain runs.

In another aspect, the concept of using the NSH header information to report on resource utilization information for network functions on a container or virtual network function level to a controller is concept that is implemented for a number of different approaches. For example, the resource utilization information can be used to trigger a number of controller functions to perform one or more of: (1) making modifications to the SFC, (2) performing an orchestration function, (3) migrating data and/or a container, (3) changing traffic routing, and/or (4) making improvements to the SFC. These changes can be made to implement policies or service level agreements at the network layer based on the network utilization received from the various containers. The data received from the VNFs can be “live” or in real-time and dynamic changes and modifications to the SFC environment can be virtually live. The changes to the SFC can include adding at least one VNF or removing one or more VNF.

Further, information can be received at the controller 212 or scheduler 308 relate to identifications at certain levels. Container IDs, cloud IDs, tenant IDs, workload IDs, sub-workload IDs, segment IDs, VNIDs, and so forth can be received and used to apply policies based on the respect ID(s) received and the resource usage information received as well. Thus, policy enforcement (thresholds exceeded for a tenant or a workload, etc.) can be applied on a particular user. Tiered classes of users can be thus managed using this approach.

The network utilization can also apply to the traffic flowing through a network function. By studying the traffic, certain information can be inferred. Certain network function may report that a particular VNF is handling certain traffic from so many services and so many tenants. The report may indicate that from a hardware/resource standpoint that the VNF is over-utilized on the amount of tenant traffic that it is handling. The traffic can then be split across several network functions as instructed by the controller 212 or scheduler 308. In another aspect, the resource usage may be policy based. Certain tenants may be allowed a predetermined amount of data flow. One VNF can be handling the data flow for two tenants. If the tenants are communicating more data than their predetermined amount (which may not overwhelm the server at all), then the reported data can indicate an oversubscription but it is on a policy basis, not a hardware basis. The controller can still load-balance across VNFs. Resource utilization can therefore can be related to the type of traffic running through a VNF and whether that traffic complies with either hardware/virtual environment capabilities or policy requirements.

One aspect an also include a computer-readable storage device which stores instructions for controlling a processor to perform any of the steps disclosed herein. The storage device can include any such physical devices that store data such as ROM, RAM, harddrives of various types, and the like.

Claim language reciting “at least one of” a set indicates that one member of the set or multiple members of the set satisfy the claim. For example, claim language reciting “at least one of A and B” means A, B, or A and B.

The present examples are to be considered as illustrative and not restrictive, and the examples is not to be limited to the details given herein, but may be modified within the scope of the appended claims.

What is claimed is:

1. A method comprising:
receiving, from a virtual network function operating in a container within a service function chain, and at a container orchestration layer, resource usage data;
determining whether the resource usage data has surpassed a threshold to yield a determination; and
when the determination indicates that the threshold is met, migrating the container to a new location within a network

2. The method of claim 1, wherein the resource usage data is communicated via a network service header field.

3. The method of claim 2, wherein the resource usage data is type 1 or type 2 metadata.

4. The method of claim 1, wherein the threshold is based on one of a usage-based policy, another policy or a service level agreement.

5. The method of claim 1, wherein the resource usage data comprises one of memory depletion, a compute oversubscription, a resource utilization, application requirements, and bandwidth.

6. The method of claim 1, wherein the new location in the network comprises a containerized virtual network function chosen from a pool of containerized network functions.

7. The method of claim 1, further comprising:
receiving one of application requirements and service function chain metadata and receiving existing service function chain data.

8. The method of claim 7, further comprising:
based on this additional data, modifying the service function chain by maintaining a service function chain functions and/or order while changing a location in the network on which a respective virtual network function within the service function chain runs.

9. A system comprising:
a processor; and
a computer-readable storage device storing instructions which, when executed by the processor, cause the processor to perform operations comprising:
receiving, from a virtual network function operating in a container within a service function chain, and at a container orchestration layer, resource usage data;
determining whether the resource usage data has surpassed a threshold to yield a determination; and
when the determination indicates that the threshold is met, migrating the container to a new location within a network

10. The system of claim 9, wherein the resource usage data is communicated via a network service header field.

11. The system of claim 10, wherein the resource usage data is type 1 or type 2 metadata.

12. The system of claim 9, wherein the threshold is based on one of a usage-based policy, another policy or a service level agreement.

13. The system of claim 9, wherein the resource usage data comprises one of memory depletion, a compute oversubscription, a resource utilization, application requirements, and bandwidth.

14. The system of claim 9, wherein the new location in the network comprises a containerized virtual network function chosen from a pool of containerized network functions.

15. The system of claim 9, wherein the computer-readable storage device stores additional instructions which, when executed by the processor, cause the processor to perform operations further comprising:
receiving one of application requirements and service function chain metadata and receiving existing service function chain data.

16. The system of claim 15, wherein the computer-readable storage device stores additional instructions which, when executed by the processor, cause the processor to perform operations further comprising:
based on this additional data, modifying the service function chain by maintaining a service function chain functions and/or order while changing a location in the network on which a respective virtual network function within the service function chain runs.

17. A computer-readable storage device storing instructions which, when executed by a processor, cause the processor to perform operations comprising:
receiving, from a virtual network function operating in a container within a service function chain, and at a container orchestration layer, resource usage data;
determining whether the resource usage data has surpassed a threshold to yield a determination; and
when the determination indicates that the threshold is met, migrating the container to a new location within a network

18. The computer-readable storage device of claim 17, wherein the resource usage data is communicated via a network service header field.

19. The computer-readable storage device of claim 17, wherein the threshold is based on one of a usage-based policy, another policy or a service level agreement.

20. The computer-readable storage device of claim 17, wherein the resource usage data comprises one of memory depletion, a compute oversubscription, a resource utilization, application requirements, and bandwidth.
